(19) United States
(12) Patent Application Publication
(10) Pub. No.: US 2021/0327660 A1
(43) Pub. Date: Oct. 21, 2021

(54) KEYBOARD STRUCTURE

(71) Applicant: Silitek Electronics (Dongguan) Co., Ltd, Dongguan (CN)

(72) Inventor: Ke-Cheng WANG, Dongguan (CN)

(21) Appl. No.: 17/077,868

(22) Filed: Oct. 22, 2020

(30) Foreign Application Priority Data
Apr. 16, 2020 (CN) 202010300017.4

(51) Int. Cl. H01H 13/70; H01H 13/14; H01H 13/20

(52) U.S. Cl. CPC H01H 13/70; H01H 2233/07; H01H 13/20; H01H 13/14

(57) ABSTRACT

A keyboard structure including a base, a frame and several keys is provided. The frame is disposed on the base. The keys are disposed on the base and are separated from each other by the frame. From top to bottom, each key sequentially includes a cap, a limiting structure, an elastic member and a diaphragm switch element. The elastic member is disposed on the diaphragm switch element, the cap is disposed on the elastic member, and the limiting structure is engaged with the cap, such that the cap can move relative to the diaphragm switch element in a vertical direction. The surrounding surface of the cap has a flange, which contacts the bottom of the frame in the vertical direction. Thus, dusts or moisture can hardly infiltrate the keyboard structure and the waterproof and dustproof functions of the keyboard structure can be improved.

This application claims the benefit of People's Republic of China application Serial No. 202010300017.4, filed Apr. 16, 2020, the subject matter of which is incorporated herein by reference.

### BACKGROUND OF THE INVENTION

### Field of the Invention

The invention relates in general to a keyboard structure, and more particularly to a waterproof and dustproof keyboard structure.

### Description of the Related Art

Conventional keyboard includes a cap, a scissor lift structure, an elastic member and a thin-film circuit board. The elastic member, disposed under the cap, provides an elastic restoring force to the cap. The scissor lift structure is configured to support the cap, such that when the cap is pressed, the cap can press the elastic member and transfer a downforce to trigger the switch element disposed on the thin-film circuit board.

However, dusts may easily enter the keyboard via the gap between two adjacent caps. Meanwhile, if the keyboard is not covered with a waterproof cover, moisture also may easily enter the keyboard via the gap between two adjacent caps. Therefore, it has become a prominent task for the industries to resolve the above infiltration problems of dusts and water.

### SUMMARY OF THE INVENTION

The invention is directed to a keyboard structure capable of improving the waterproof and dustproof functions of the keyboard.

According to one embodiment of the present invention, a keyboard structure is provided. The keyboard structure includes a base, a frame and several keys. The frame is disposed on the base. Several keys are disposed on the base and are separated from each other by the frame. From the top to the bottom, each key sequentially includes a cap, a limiting structure, an elastic member and a diaphragm switch element. The elastic member is disposed on the diaphragm switch element, the cap is disposed on the elastic member, and the limiting structure is engaged with the cap, such that the cap can move relative to the diaphragm switch element in a vertical direction. The surrounding surface of the cap has a flange, which contacts the bottom of the frame in the vertical direction. Thus, dusts or moisture can hardly infiltrate the keyboard structure and the waterproof and dustproof functions of the keyboard structure can be improved.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a keyboard structure according to an embodiment of the present invention.

FIG. 2 is an explosion diagram of a local area A of a keyboard structure according to an embodiment of the present invention.

FIG. 3 is a cross-sectional view of a key of a keyboard structure according to an embodiment of the present invention.

FIG. 4 is a schematic diagram of the interior of a keyboard structure adopting hot melt fixing according to an embodiment of the present invention.

FIG. 5 is a cross-sectional view of a flange of a cap according to another embodiment of the present invention.

FIG. 6 is an explosion diagram of a local area of a keyboard structure according to an embodiment of the present invention.

FIG. 7 is a cross-sectional view of a key of a keyboard structure according to an embodiment of the present invention.

### DETAILED DESCRIPTION OF THE INVENTION

Detailed descriptions of the invention are disclosed below with a number of embodiments. However, the disclosed embodiments are for explanatory and exemplary purposes only, not for limiting the scope of protection of the invention.

### First Embodiment

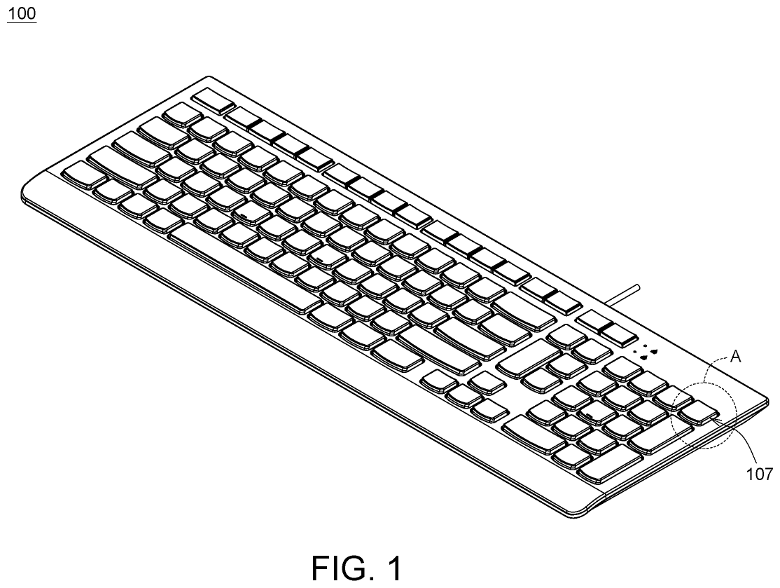

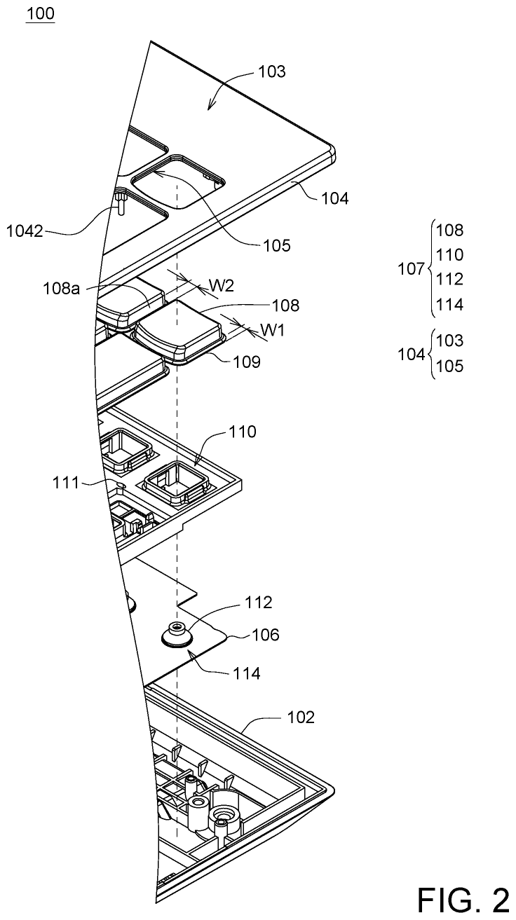

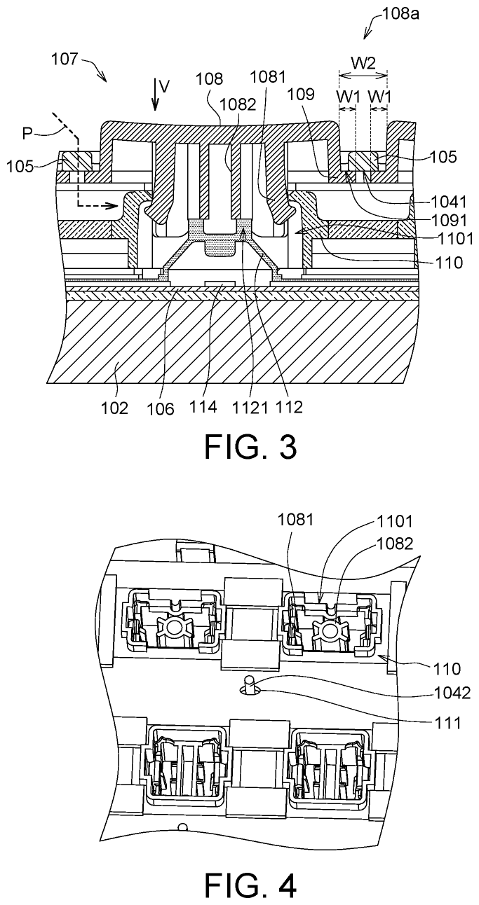

FIG. 1 is a schematic diagram of a keyboard structure 100 according to an embodiment of the present invention. FIG. 2 is an explosion diagram of a local area A of a keyboard structure 100 according to an embodiment of the present invention. FIG. 3 is a cross-sectional view of a key 107 of a keyboard structure 100 according to an embodiment of the present invention. Refer to FIG. 1, FIG. 2 and FIG. 3. In an embodiment, the keyboard structure 100 includes a base 102, a frame 104, a thin-film circuit board 106 and keys 107. The base 102 is located at the bottom of the keyboard structure 100 to support the thin-film circuit board 106 and the keys 107. The frame 104 is disposed on the base 102. Specifically, the frame 104 is fixed on the base 102 using a screw or a fastener.

The keys 107 are disposed on the base 102, and each key 107 represents at least one character, function key or symbol. The keys 107 form a keyboard structure 100 with a QWERTY layout or other layout. The keys 107 are separated from each other by the frame 104. From the top to the bottom, each key 107 sequentially includes a cap 108, a limiting structure 110, an elastic member 112 and a diaphragm switch element 114 as indicated in FIG. 3.

Refer to FIG. 2. The frame 104 includes an outer frame portion 103 and several spacers 105 (ribs) connected to outer frame portion 103. In an embodiment, the outer frame portion 103 and the spacers 105 can be integrally formed in one piece by way of plastic injection. Then, the frame 104 covers the base 102, on which the keys 107 and the thin-film circuit board 106 are disposed, to form a keyboard structure 100. In the present embodiment, the outer frame portion 103 can be fixed on the base 102 using a screw or a fastener, and the keys 107 are separated by the spacers 105. That is, the outer frame portion 103 surrounds the periphery of each of the keys 107, and the spacers 105 cover the top surface of the flange 109 of the cap 108 of each of the keys 107.

Refer to FIG. 3. The elastic member 112, disposed on the diaphragm switch element 114, can be formed by a rubber dome or other supporter. The elastic member 112 is disposed under the cap 108 to provide an elastic restoring force to the cap 108. When the cap 108 is not pressed, the cap 108 is located at an initial position by the elastic restoring force of the elastic member 112.

Besides, the limiting structure 110 is disposed on the thin-film circuit board 106 and is engaged with the cap 108 in the initial position. For example, the cap 108 includes an engaging member 1081 extended downwards from the bottom of the cap 108, and the limiting structure 110 includes an engaging groove 1101 configured to receive the engaging member 1081, and the engaging member 1081 and the engaging groove 1101 are engaged in a vertical direction V, such that the cap 108 can move relative to the diaphragm switch element 114 in the vertical direction V. Moreover, the cap 108 is disposed on the elastic member 112, and when the cap 108 is pressed to move downwards, the elastic member 112 triggers the diaphragm switch element 114 to generate a pressing signal. The diaphragm switch element 114 is electrically connected to the thin-film circuit board 106 which transmits the pressing signal to enable an external device (such as a computer) to generate a corresponding operation.

Refer to FIG. 3. The elastic member 112 is located in the engaging groove 1101, and the center column 1082 of the engaging member 1081 preloads the elastic member 112. In an embodiment, the preload stroke of the elastic member 112 is in a range of 0.2-0.5 mm, and the dome protrusion 1121 of the elastic member 112 pushes upwards against the cap 108 to make the flange 109 contact with the frame 104, such that the contact tightness between the flange 109 of the cap 108 and the frame 104 becomes stronger and achieves waterproof and dustproof effects.

Refer to FIG. 2 and FIG. 3. In an embodiment, to improve the waterproof and dustproof functions of the keyboard structure 100, the surrounding surface of the cap 108 has a flange 109, which contacts the bottom 1041 of the frame 104 in the vertical direction V. The spacers 105 of the frame 104 directly cover the flange 109 between adjacent caps 108 to avoid dusts or moisture directly entering the keyboard structure 100 via the cap gap 108a and block the infiltration path P as indicated in FIG. 3. Thus, the waterproof and dustproof functions of the keyboard structure 100 can be improved.

Refer to FIG. 2. In an embodiment, the flange 109 is located in the cap gap 108a between two adjacent caps 108. The cap gap 108a has a width W2 greater than two times of the width W1 of the flange 109, that is, W2>2W1, to assure that the two adjacent caps 108 can be independently pressed without mutual interference. Specifically, the width W2 of the cap gap 108a is greater than two times of the width W1 of the flange 109 by 0.3 to 0.4 mm, that is, W2-2W1=0.3 to 0.4 mm. Thus, the gap between the two adjacent flanges 109 is very small (such as 0.3 to 0.4 mm), and the frame 104 is disposed in the cap gap 108a and covers the two adjacent flanges 109, such that dusts or moisture can hardly infiltrate the keyboard structure 100 and the waterproof and dustproof functions of the keyboard structure 100 can be improved. In other embodiments, the size of the gap between two adjacent flanges 109 can also be greater than 0.3 to 0.4 mm, as long as the flanges 109 can be in contact with the bottom surface of the frame 104 and avoid the mutual interference between the two adjacent keycaps 108, and thus the size of the gap between two adjacent flanges 109 can be adjusted according to requirements (depending on the relative configuration of keys and frame).

Referring to FIG. 4, a schematic diagram of the interior of a keyboard structure 100 adopting hot melt fixing manner according to an embodiment of the present invention is shown. As disclosed above, when the outer frame portion 103 and the spacers 105 are formed by way of plastic injection, there are several plugs 1042 formed on the bottom of the spacers 105 at the same time. The plugs 1042 can be inserted into the holes 111 of the limiting structure 110. The plugs 1042 can further be heated and melted, such that the limiting structure 110 and the spacers 105 can be fixed by the melted plugs 1042 and form an abutting structure by fusion (that is, hot melt fixing manner).

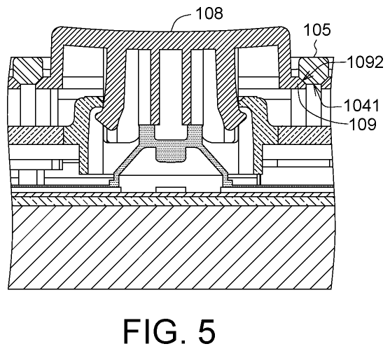

FIG. 5 is a cross-sectional view of a flange 109 of a cap 108 according to another embodiment of the present invention. Refer to FIG. 3 and FIG. 5. The surface by which the flange 109 of the cap 108 contacts the bottom 1041 of the frame 104 can be a horizontal plane 1091 or an inclined plane 1092. That is, the flange 109 of the cap 108 can have a horizontal contact or an inclined contact with the bottom of the frame 104. The inclined contact has a smaller contact area than the horizontal contact, and the smaller the contact area, the smaller the rebound noise of the cap 108. In the present embodiment, the flange 109 of the cap 108 can be formed of a soft buffer material to reduce the rebound noise of the cap 108, and the present invention does not have specific restrictions regarding the said arrangement.

Also, the contact between the flange 109 of the cap 108 and the bottom of the frame 104 can block the light to reduce the light leakage of the keyboard structure 100 with light emitting function.

### Second Embodiment

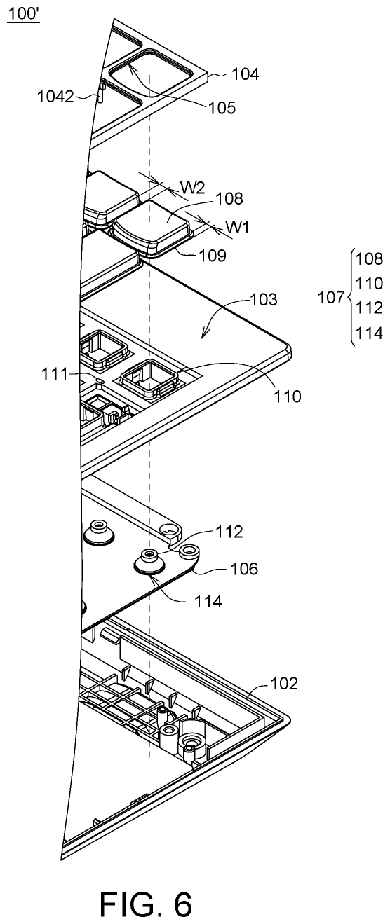

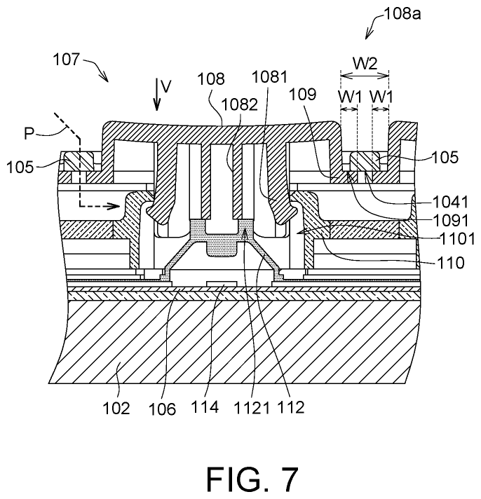

FIG. 6 is an explosion diagram of a local area of a keyboard structure 100′ according to an embodiment of the present invention. FIG. 7 is a cross-sectional view of a key 107 of a keyboard structure 100′ according to an embodiment of the present invention. Refer to FIG. 6 and FIG. 7. In the present embodiment, the keyboard structure 100′ includes a base 102, an outer frame portion 103, a frame 104, a thin-film circuit board 106 and several keys 107. Detailed structure of the base 102, the frame 104, the thin-film circuit board 106 and key 107 are already disclosed in the above embodiment and are not repeated here.

The present embodiment is different the above embodiment in that: the frame 104 only includes the spacers 105, the outer frame portion 103 surrounds the periphery of each of the spacers 105, the outer frame portion 103 and the limiting structure 110 are integrally formed in one piece, and the caps 108 of the keys 107 are separated by the spacers 105. That is, the outer frame portion 103 is integrally formed in one piece with the limiting structure 110 instead of the spacers 105. The caps 108 can be assembled on the integrally formed body of the outer frame portion 103 and the limiting structure 110. Then, the spacers 105 cover the gap between the caps 108 to form a keyboard structure 100′.

Refer to FIG. 7. The surrounding surface of the cap 108 has a flange 109, which contacts the bottom 1041 of the frame 104 in a vertical direction V. The spacers 105 of the frame 104 directly cover the flange 109 between two adjacent caps 108 to avoid dusts or moisture directly entering the keyboard structure 100 via the cap gap 108a and block the infiltration path P as indicated in FIG. 7. Thus, the waterproof and dustproof functions of the keyboard structure 100′ can be improved.

Refer to FIG. 7. In the present embodiment, the flange 109 is located in the cap gap 108a between two adjacent caps 108. The cap gap 108a has a width W2 greater than two times of the width W1 of the flange 109, that is, W2>2W1, to assure that the two adjacent caps 108 can be independently pressed without mutual interference. Specifically, the width W2 of the cap gap 108a is greater than two times of the width W1 of the flange 109 by 0.3 to 0.4 mm, that is, W2-2W1>0.3 to 0.4 mm. Thus, the gap between the two adjacent flanges 109 is very small, and the frame 104 is disposed in the cap gap 108a and covers the two adjacent flanges 109, such that dusts or moisture can hardly infiltrate the keyboard structure 100′ and the waterproof and dustproof functions of the keyboard structure 100′ can be improved.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A keyboard structure, comprising:
a base;
a frame disposed on the base; and
a plurality of keys disposed on the base and separated from each other by the frame, wherein, each key from top to bottom sequentially comprises a cap, a limiting structure, an elastic member and a diaphragm switch element, the elastic member is disposed on the diaphragm switch element, the cap is disposed on the elastic member, and the limiting structure is engaged with the cap, such that the cap moves relative to the diaphragm switch element in a vertical direction, wherein a surrounding surface of each of the caps has a flange, and the flange contacts a bottom of the frame in the vertical direction.

2. The keyboard structure according claim 1, wherein a surface by which the flange contacts the bottom of the frame is a horizontal plane or an inclined plane.

3. The keyboard structure according claim 1, wherein the flange is located in a cap gap between two adjacent caps and the flange has a width less than a half of the cap gap.

4. The keyboard structure according claim 3, wherein the frame is disposed in the cap gap, and covers the flanges of the two adjacent caps, and a gap is formed between the two adjacent flanges.

5. The keyboard structure according claim 1, wherein the cap comprises an engaging member, the limiting structure comprises an engaging groove configured to receive the engaging member, and the engaging member and the engaging groove are engaged in the vertical direction.

6. The keyboard structure according claim 5, wherein the elastic member is located in the engaging groove, and the engaging member preloads the elastic member located below the engaging member, and the elastic member pushes upward against the cap to make the flange contact with the frame.

7. The keyboard structure according claim 1, wherein the frame comprises an outer frame portion and a plurality of spacers, the outer frame portion connects the spacers, and the keys are separated by the spacers.

8. The keyboard structure according claim 1, wherein the frame comprises a plurality of spacers, and the keys are separated by the spacers.

9. The keyboard structure according claim 8, further comprising an outer frame portion surrounding a periphery of each of the spacers, wherein the outer frame portion and the limiting structure are integrally formed in one piece.

10. The keyboard structure according claim 7, wherein the limiting structure and the spacers are fixed using hot melt.

11. The keyboard structure according claim 8, wherein the limiting structure and the spacers are fixed using hot melt.

12. The keyboard structure according claim 1, further comprising a thin-film circuit board disposed on the base, wherein the thin-film circuit board is electrically connected to the diaphragm switch element of each of the keys.
